(19) United States
(12) Patent Application Publication
(10) Pub. No.: US 2017/0018049 A1
(43) Pub. Date: Jan. 19, 2017

(54) PRINTING LEDS, BATTERY, AND DRIVER CIRCUIT ON THIN SUBSTRATE FOR PACKAGING

(71) Applicant: Nthdegree Technologies Worldwide Inc., Tempe, AZ (US)

(72) Inventors: Alexander S. Ray, Tempe, AZ (US); Richard A. Blanchard, Los Altos, CA (US); Bradley S. Oraw, Chandler, AZ (US); Shawn Barber, Bay City, MI (US); Mark D. Lowenthal, Vancouver, WA (US); William J. Ray, Fountain Hills, AZ (US); Neil O. Shotton, Tempe, AZ (US); David Moffenbeier, Lake Oswego, OR (US); Vera N. Lockett, Phoenix, AZ (US)

(21) Appl. No.: 14/801,374

(22) Filed: Jul. 16, 2015

(51) Int. Cl. G06Q 90/00; F21V 23/02; F21V 23/04

(52) U.S. Cl. CPC G06Q 90/00; F21V 23/0407; F21V 23/0464; F21V 23/023; F21V 23/0471; F21Y 2101/02

(57) ABSTRACT

On a flexible substrate is printed, LEDs, a battery, a flasher, and an actuator. The actuator may be a photo-switch that causes the battery and flasher to periodically energize the LEDs when a sufficient ambient light impinges on the actuator. The substrate may be an insert in a transparent package containing a product, such as a razor. When the package is in the front of a display in a store, the ambient light causes the LEDs to flash, such as every 10-30 seconds to attract consumers to the product. The substrate may also form part of the outer surface of the package. The flasher may simply flash the LEDs or create a dynamic display by energizing different groups of the LEDs at different times.

### FIELD OF THE INVENTION

This invention relates to printing light emitting diodes (LEDs), batteries, LED driver components, and an actuator on a flexible substrate, such as for inclusion in a product package for advertising or for other temporary uses.

### BACKGROUND

In stores where consumers shop, the packaging of consumer products, such as razors, golf balls, etc., is important for getting the consumers' attention. Such attention-getting advertising typically consists of printed material on the outside of the package. In some cases, the package is a clear plastic, so the consumer can see the product, and printed advertising is inside of the package.

Any eye-catching advertising on a product's package will draw the consumers' attention to the package and increase the likelihood that the product will be sold.

Thus, what is needed is a technique for providing increased attention-getting advertising on a product package.

### SUMMARY

On a thin flexible substrate is printed LEDs, one or more batteries, an actuator circuit, and a driver circuit for the LEDs. The substrate may be cardboard, a plastic film, or other inexpensive material. The printed circuitry may be placed in a transparent product package or form an outer surface of the package. The LEDs may be printed in a customized pattern, or a separate mask layer may be laminated over the printed circuit such that openings in the mask layer define the viewed light pattern.

The printed driver circuit may be a simple flashing circuit to extend battery life and create an attention-getting dynamic display. A printed battery may have a life exceeding 500 hours while driving the flashing LEDs. So that the LEDs do not flash while the package is not being displayed, a photodetector switch may also be printed to activate the driver only when sufficient ambient light is detected by the photodetector switch.

In one embodiment, the flasher/driver drives different groups of the LEDs at different times so the displayed pattern appears to move. If a decorative mask layer is used over the printed circuit, the openings in the mask layer may define the dynamic light pattern. Standard color ink may be printed on the mask layer for advertising.

Other uses of the printed circuit for attention-getting purposes are envisioned.

In another embodiment, a generic programmable array of active and passive components, including LEDs, is printed. Then, the interconnections of the components are customized for a particular application using printed metal traces. For example, the flashing frequency may be programmable using various resistor or capacitor values, or different patterns of LEDs may be energized.

The disposable printed circuit is inexpensive since it may be entirely printed using a roll-to-roll printing process.

### BRIEF DESCRIPTION OF THE DRAWINGS

FIG. 1 is a front view of a plurality of product package inserts, prior to being singulated from a roll, where a flashing star pattern (or other design) acts as an attention-getting tool in a consumer shopping environment.

FIG. 2 is a front view of a single, printed product package insert showing a star pattern of LEDs that is energized using a printed battery and a flasher, where the flasher is enabled only when sufficient ambient light is detected by a photo-switch.

FIG. 3 illustrates the insert of FIG. 2 in a transparent package behind a razor, where the star pattern flashes when the package is exposed to ambient light by being displayed in a store.

FIG. 4 illustrates a roll-to-roll printing process that may be used to print the entire circuit.

FIG. 5 is a cross-section of a simplified printed circuit and a mask layer overlying the circuit, where the mask layer has openings that define the light pattern and a decorative face.

FIG. 6 illustrates two programmable cells in an array of cells, where the cells may be identical or different, and where the cells are programmed using printed metal traces to perform a customized function. A printed battery drives the customized circuit.

### DETAILED DESCRIPTION

It is known, by the present assignee's own work, how to form and print microscopic 2-terminal vertical light emitting diodes (LEDs), with the proper orientation, on a flexible conductive substrate and connect the LEDs in parallel to form a light sheet. Details of such printing of LEDs can be found in US application publication US 2012/0164796, entitled, Method of Manufacturing a Printable Composition of Liquid or Gel Suspension of Diodes, assigned to the present assignee and incorporated herein by reference.

It is also known, by the present assignee's own work, how to form and print bipolar transistors, MOSFETs, resistors, diodes, capacitors, inductors and how to interconnect such components with a printed metal pattern to form a variety of circuits. Details of such printing of circuits can be found in US application publication US 2014/0268591, entitled, Printing Complex Electronic Circuits, assigned to the present assignee and incorporated herein by reference.

It is also known, by the present assignee's own work, how to form and print very thin batteries. Details of such printing of batteries can be found in US application publication US 2014/0302373, entitled, Printed Energy Storage Device, assigned to the present assignee and incorporated herein by reference.

Such technologies may be employed for the novel purpose of forming a disposable, self-powered, attention-getting product package.

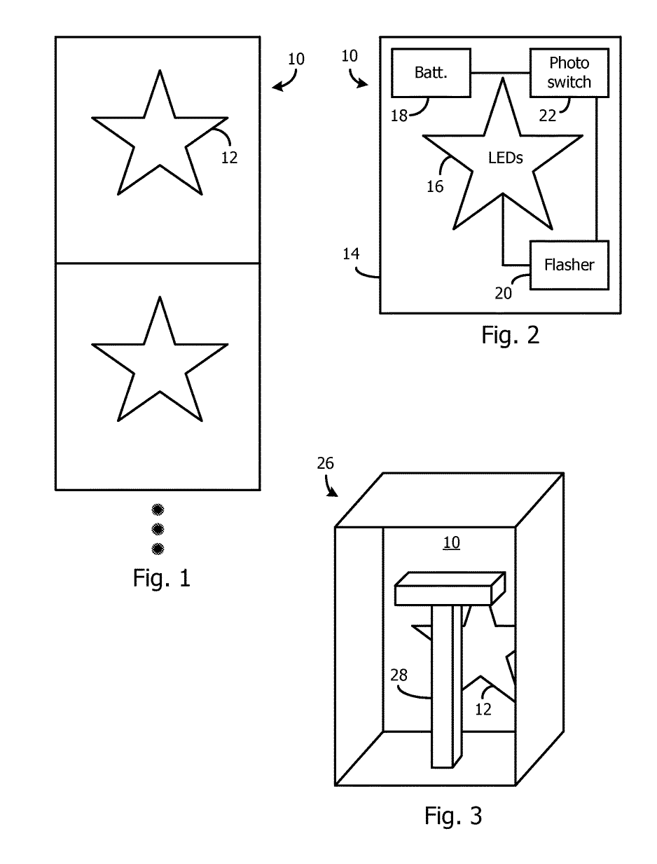

FIGS. 1-5 are directed to one example of forming a thin, flexible printed package insert, where the outer portion of the package is transparent plastic. Many other uses of the concept are envisioned.

FIG. 1 illustrates the fronts of a plurality of package inserts 10, fabricated in a roll-to-roll printing process, prior to singulation from the roll. The star pattern 12 may represent the pattern of printed LEDs or an opening in a decorative mask layer behind which resides a larger array of LEDs.

FIG. 2 illustrates the front of a thin, flexible substrate 14 on which is printed various electrical circuits. The LEDs 16 are printed in a star pattern using any suitable printing process, such as screen printing, flexography, gravure, etc. Alternatively, the LEDs may be printed in any pattern, such as a rectangle, and a decorative mask layer overlies the LEDs to customize and define the light pattern. Therefore, the insert can be generic to a wide variety of products, and the decorative mask layer may be customized for each product.

In one embodiment, the LEDs 16 are GaN based and emit blue light. A phosphor can be printed over the LEDs, or on a transparent film of the decorative mask layer, to create any color. The microscopic LEDs may be printed in any density to create the desired brightness and pattern definition.

Each LED 16 includes standard semiconductor GaN layers, including an n-layer, an active layer, and a p-layer. The LEDs 16 are separated from a wafer to form singulated microscopic dice. The microscopic LEDs are then uniformly infused in a solvent, including a viscosity-modifying polymer resin, to form an LED ink for printing, such as screen printing or flexographic printing. The LEDs may be shaped so that they self-orient on the surface. Over 90% like orientation has been achieved by the assignee.

The LEDs 16 are printed on a conductive layer on a flexible substrate. Because of the comparatively low concentration, the LEDs 16 will be printed as a monolayer and be fairly uniformly distributed over the conductor layer. The solvent is then evaporated by heat using, for example, an infrared oven. After curing, the LEDs 16 remain attached to the underlying conductor layer with a small amount of residual resin that was dissolved in the LED ink as a viscosity modifier. The adhesive properties of the resin and the decrease in volume of resin underneath the LEDs 16 during curing press the bottom LED electrode against the underlying conductor, making ohmic contact with it. A dielectric layer is then printed over the surface to encapsulate the LEDs 16 and further secure them in position. A top transparent conductor layer (e.g., ITO) is then printed over the dielectric layer to electrically contact the top LED electrodes and is cured in an oven appropriate for the type of transparent conductor being used. If needed to spread current, thin metal bus bars are then printed along the transparent conductor layer. The conductor layers electrically terminate at anode and cathode leads for supplying power to the LEDs 16. Thus, the individual LEDs 16 are connected in parallel by being sandwiched between the two conductor layers. In another embodiment, the conductor layer(s) may be segmented to form groups of LEDs, and the LEDs in each group may be separately addressed. The groups may also be connected in any combination of series and parallel depending on the electrical requirements.

FIG. 2 also shows a battery 18 printed on the substrate 14. The battery 18 may be a printed zinc manganese-dioxide (ZnMnO₂) battery, as described in the assignee's US application publication 2014/0302373, or may be a printed lithium-ion battery or other type of printed battery. Various types of printed batteries are well-known and described in publications. Batteries may be connected in series and/or parallel to provide the proper current and voltage to drive the LEDs 16 for the desired length of time.

FIG. 2 also shows a flasher circuit 20, which may be a conventional circuit but formed using printed components. Many types of known flasher circuits can be used and are typically composed of transistors, resistors, diodes, and capacitors. The assignee's US application publication US 2014/0268591 describes printing circuits using such components. For printing transistors, microscopic singulated transistor dies are infused in a solvent, similar to the way the LEDs are printed. The transistor ink is then printed on a conductor layer. Two more conductor layers may be used to contact the 3-terminal transistors so the transistors are connected in parallel. Resistors may be printed by printing resistive material, such as carbon and controlling the size of the resistor to set its value. The capacitors may be super capacitors that include special electrode materials and electrolytes, or the capacitors may be ordinary capacitors. Printing capacitors is well-known. A simple flasher circuit comprises a capacitor whose charge is ramped up, using a current source, until the ramping capacitor voltage triggers a transistor switch which connects LEDs across a voltage and discharges the capacitor. The self-oscillating cycle then begins again. The value of the capacitor and/or a resistor sets the flash frequency. In one embodiment, the LEDs are only flashed every 10-30 seconds for less than 1 second while in the package to conserve battery life.

FIG. 2 also shows a photo-switch 22, which may be printed photo-diodes or photo-transistors. When there is sufficient light incident of the photo-switch 22, current is conducted through the photo-switch 22 that is used to turn on the flasher circuit 20. Photo-switch circuits are well known. The photo-diodes or photo-transistors may be microscopic devices that are printed and connected in parallel in a manner similar to that used for printing the LEDs 16.

Generally, due to the limitations in printing circuitry, the circuitry to be formed should be relatively simple.

In another embodiment, the battery 18 is not printed, and a conventional coin-type battery is used. The coin-type battery may be installed in a suitable receptacle soldered to the pads of the printed circuit.

As shown in FIG. 3, the resulting printed insert 10 of FIGS. 1 and 2 may then be placed in a transparent or translucent package 26 behind the product, such as a razor 28. During shipping to the store, there is no light, so the flasher 20 is disabled by the photo-switch 22. When the package 26 is displayed in the store and is in a front position for being viewed by the consumer, the ambient light incident on the photo-switch 22 causes the flasher circuit 20 to be turned on to begin the flashing of the LEDs 16. When the store closes at night, the flashing will stop and battery life is conserved. With one type of printed battery, the battery life may exceed a few months while the LEDs flash at a low frequency. Packages 26 that are not in the front of the display rack will have their photo-switch 22 blocked by other packages 26, so the battery life should exceed a few years.

Alternatively, the printed circuit may be on a material which forms the outside of the package, such as a cardboard box.

The printed circuit may be less than 1 mm thick, depending on the substrate material.

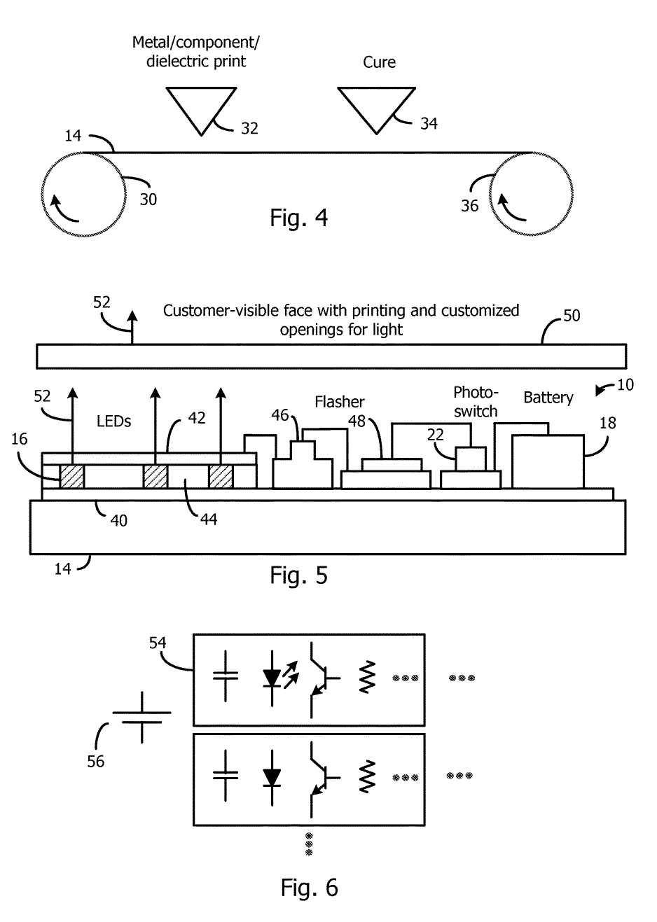

FIG. 4 illustrates how the package insert 10 of FIG. 2 may be formed using a roll-to-roll process. The starting substrate 14 is provided on a first roll 30. As the substrate 14 is unrolled, it is subjected to a printing stage 32 and a curing stage 34 to form the circuitry. The printing stage 32 comprises a variety of stages for the various components and conductor layers. The completed package inserts 10 are then taken up by a take-up roller 36 and later singulated.

FIG. 5 is a cross-sectional view of a simplified example of the insert 10. The various components would be repeated many times since many of the microscopic components must be connected in parallel to conduct sufficient current to drive the LEDs 16. The bottom conductor layer 40 and transparent top conductor layer 42 sandwiching the LEDs 16 are shown. The conductor layer 40 may be used by all the circuitry as a ground plane. A dielectric layer 44 encapsulates the sides of the LEDs 16. The photo-switch 22 is represented by a single photo-diode, and the flasher is represented by a transistor 46 and a super capacitor 48. The printed battery 18 is also shown.

The LEDs 16 may be in a decorative pattern or in a generic rectangle pattern. A decorative mask layer 50 may include openings or transparent plastic windows that precisely define the light emission pattern. Light rays 52 are shown. The mask layer 50 may have any advertising printed on top of it. The mask layer 50 may be cardboard, plastic, or any other material. The mask layer 50 may be adhesively secured over the printed circuit.

In one embodiment, the mask layer 50 has a plurality of openings, such as representing sections of a wheel. Each opening has a separate group of LEDs behind it, and the groups of LEDs are energized in sequence by the flasher 20 to provide an animated display.

If the openings are a transparent plastic material, a phosphor layer may cover the transparent material to create any combination of colors with any type of pattern. Alternatively, the phosphor layer is deposited over the printed LED layer. Quantum dots may also be used.

If mass-produced, each insert 10 can be made for less than $0.25. Conversely, if the same circuit was formed using discrete components that were required to be separately handled and mounted on a printed circuit board, the cost would likely exceed $2.00.

Some examples of variations of the printed circuitry used in packaging for gaining the attention of customers include the following.

An infrared (IR) sensor and detection circuit can be printed for optically sensing a heat signature. The circuit triggers the LED display to turn on, such as for flashing, when a person is detected nearby.

A motion sensor and detection circuit can be printed for optically sensing motion near the package. The circuit triggers the LED display to turn on when a person is approaching.

A shadow sensor and detection circuit can be printed for optically sensing when a person in front of the package blocks ambient light. The circuit then triggers the LED display to turn on.

An external video camera in the area of the package detects the presence of shoppers in the area of the package and transmits a trigger signal to the circuitry in the package to activate the LED display.

A magnetic sensor can be printed for detecting an external magnetic field. A magnet is externally provided near the front of a shelf supporting the packages. When a package is moved to the front of the shelf near the magnet, the magnetic sensor in that package triggers the LED display to turn on.

A sound sensor can be printed for detecting sounds. When a sound of a sufficient amplitude is detected, it triggers the LED display to turn on.

A proximity or touch sensor can be printed that detects a change in capacitance. The change in capacitance may be by a shopper coming close to the package, or touching the package, or stepping on a conductive mat in front of the display. If a certain change in capacitance is detected, the LED display is turned on.

When a case of packages is opened by a store clerk when stocking shelves to display the packages, a trigger mechanism informs the packages that they are being displayed. As a result, the LED displays in all the packages are activated. The package battery life may last for over a month. In an alternative embodiment, only the above-described proximity sensors are activated when the packages are taken out of the case to save power. For example, the clerk may pull a dielectric strip from each package to connect the battery terminals to the circuitry. Or a magnet in the case may provide a magnetic field that is sensed by a magnetic sensor in each package and, upon the magnetic field being terminated, the LED display is activated.

An electronic sensor in each packaged circuit detects the circuit in a nearby package to allow the circuits to interact. For example, the sensors may allow the LED displays in the packages to flash in a synchronized pattern. This allows each LED display to flash less, since the customer's attention is being drawn to the entire group of packages, conserving battery life.

For all such sensors and activators for activating the LED display, the photo switch 22 of FIG. 5 may represent such sensors and activators. Alternatively, two or more sensors may be included in the package insert or on the package outer layer, and both sensors have to be triggered to turn on the LED display.

Such sensors and activators may employ conventional circuit designs, while using the assignee's printing technology to fabricate the circuits. For example, if a light sensor is to be formed, a plurality of microscopic photodetector diodes may be printed as a small group and connected in parallel to effectively form a single light sensor. The circuitry for detecting the output of the photodetector may be formed in the same way by printing microscopic dies in a group and connecting them in parallel.

FIG. 6 illustrates a programmable array of printed cells 54 and a printed battery 56. Each printed cell 54 includes unconnected components, such as diodes, LEDs, resistors, transistors, capacitors, etc. Some cells may include only LEDs for form a variable size contiguous 2-dimensional array of LEDs. The interconnection of the components is then customized for a particular application, such as to form the insert 10 of FIG. 2. The LEDs may take up a majority of the area of the substrate, such as up to 90% and can be programmed to emit light with a selectable pattern, such as for backlighting a decorative mask layer. The substrate on which the cells are printed can be any size, depending on how many cells (or LEDs) are needed for the application. The substrate may even be folded to reduce space. The flasher circuit can be programmed by interconnections to flash the LEDs in any pattern. The actuator for the LED display can also be programmed to be any of a variety of types of actuators.

In all the examples, the LED layer can be printed on one side of the substrate, and the remaining circuitry can be printed on the opposite side so that only the LEDs are viewed. Vias through the substrate provide the interconnection between the LEDs and the drive circuit.

Instead of a battery being formed, an inductor coil can be printed on the substrate, where an external magnetic field, such as provided by the product display, is converted to a current by the coil. The current is then regulated and used to energize the printed circuitry or charge the battery.

The printed LED/circuit insert can instead be used for any other application. For example, a flyer with information printed on it can also include the printed LEDs and driver circuit. The LEDs may be activated by a printed capacitive touch-sensor switch, or by a photo-switch, or by a printed accelerometer that senses movement, or by flexing. Providing a battery or photo-switch on the substrate is not required for many applications.

An antenna may also be formed on the substrate that receives an activation signal for enabling the driver circuit.

While particular embodiments of the present invention have been shown and described, it will be obvious to those skilled in the art that changes and modifications may be made without departing from this invention in its broader aspects and, therefore, the appended claims are to encompass within their scope all such changes and modifications as fall within the true spirit and scope of this invention.

What is claimed is:

1. A light emitting package for a product comprising:
a package of a product, the package containing a product for sale to a consumer in a store, wherein a portion of the package comprises:
a substrate;
printed light emitting diodes (LEDs) on the substrate,
a printed battery on the substrate;
a printed flasher circuit on the substrate; and
a printed actuator on the substrate configured to cause the battery and flasher to periodically energize the LEDs upon a triggering event occurring to attract the consumer's attention.

2. The package of claim 1 wherein the actuator is triggered in response to ambient light for causing the battery and flasher to periodically energize the LEDs when sufficient ambient light impinges on the actuator.

3. The package of claim 1 wherein the portion of the package containing the LEDs comprises an insert in a transparent or translucent outer package portion.

4. The package of claim 1 wherein the portion of the package containing the LEDs comprises a portion of an outer package layer.

5. The package of claim 1 wherein the substrate is flexible.

6. The package of claim 1 wherein the LEDs are printed in selectable groups of LEDs, and wherein the flasher circuit addresses the different groups of the LEDs at different times to create an animated display.

7. The package of claim 1 further comprising a mask layer having openings, wherein the mask layer overlies the LEDs to define a light emission pattern viewable by the consumer.

8. The package of claim 1 wherein the actuator comprising a proximity sensor that detects a presence of a person proximate the package.

9. The package of claim 8 wherein the proximity sensor detects at least one of infrared, sounds, or motion.

10. The package of claim 1 wherein the actuator detects a magnetic field.

11. The package of claim 12 wherein the magnetic field is generated by a magnet positioned in a display area for the package, and the actuator causes the battery and flasher to periodically energize the LEDs when the package is sufficiently proximate to the magnet.

12. The package of claim 1 wherein the flasher circuit comprises active devices, wherein the active devices are printed as singulated dies and connected in parallel.

13. The package of claim 1 wherein the actuator comprises active devices, wherein the active devices are printed as singulated dies and connected in parallel.

14. The package of claim 1 wherein the flasher circuit is programmable by interconnecting devices printed on the substrate.

15. The package of claim 1 wherein the actuator is programmable by interconnecting devices printed on the substrate.

16. A method for attracting a consumer to a packaged product comprising:
providing a package of a product, the package containing a product for sale to a consumer in a store, wherein a portion of the package comprises:
a substrate;
printed light emitting diodes (LEDs) on the substrate,
a printed battery on the substrate;
a printed flasher circuit on the substrate; and
a printed actuator on the substrate configured to cause the battery and flasher to periodically energize the LEDs upon a triggering event occurring to attract the consumer's attention; and
triggering the actuator by the triggering event to periodically energized the LEDs.

17. The method of claim 16 wherein the actuator is a proximity sensor and the step of triggering comprises a person being sufficiently proximate to the package to trigger the proximity sensor.

18. The method of claim 16 wherein the actuator is a magnetic sensor and the step of triggering comprises a magnet being sufficiently proximate to the package to trigger the magnetic sensor.

19. The method of claim 16 wherein the flasher circuit comprises active devices, wherein the active devices are printed as singulated dies and connected in parallel.

20. The method of claim 16 wherein the actuator comprises active devices, wherein the active devices are printed as singulated dies and connected in parallel.
